(19) United States
(12) Patent Application Publication
(10) Pub. No.: US 2013/0173799 A1
(43) Pub. Date: Jul. 4, 2013

(54) ENRICHMENT, MANAGEMENT OF MULTIMEDIA CONTENT AND SETTING UP OF A COMMUNICATION ACCORDING TO ENRICHED MULTIMEDIA CONTENT

(71) Applicant: France Telecom, Pairs (FR)

(72) Inventors: Sandrine Lamotte, Saint Michel En Greve (FR); Cedric Seureau, Lannion (FR); Philippe Haute, Tregomeur (FR)

(73) Assignee: France Telecom, Paris (FR)

(21) Appl. No.: 13/712,191

(22) Filed: Dec. 12, 2012

(30) Foreign Application Priority Data
Dec. 12, 2011 (FR) 11 61485

(51) Int. Cl. H04L 12/24

(52) U.S. Cl. CPC H04L 41/00
USPC 709/225

(57) ABSTRACT

An enrichment of multimedia content, management of multimedia content and setting up of a communication according to enriched multimedia content. A multimedia content enrichment method comprising an association of at least one identifier of a first user with multimedia content during management of said content by a communication terminal of said first user, said association allowing a second user having access to said multimedia content to request setting up of a communication between a communication terminal of said second user and a communication terminal of said first user by using one of said at least one identifier(s) of said first user.

### CROSS-REFERENCE TO RELATED PATENT APPLICATION

This application claims the benefit of French Patent Application No. 11 61485, filed on Dec. 12, 2011, in the French National Institute of Industrial Property, the entire contents of which is incorporated herein by reference.

### BACKGROUND

The invention relates to an enrichment of multimedia content, a management of multimedia content and a setting up of a communication according to enriched multimedia content.

The sharing or sending of a photo by e-mail then by MMS is a practice which appeared in the middle of the 2000s with the mass-market commercial development respectively of digital cameras and mobile telephones equipped with a digital camera and high-speed Internet access.

Thus, a mobile telephone user can choose between different methods of sharing and/or sending his photos to his close friends and family: e-mail, instant messaging, MMS, sharing, publication on a social network, etc.

When a communication user receives a photograph by e-mail, instant messaging or MMS, he often has no choice when replying to the person sending the photo other than to reply by the same communication mode, i.e. e-mail, instant messaging, MMS respectively. The same applies when a communication user views a photograph shared or published by a person.

The reply by a communication mode different from the communication mode carrying the photograph is often more complex because this response will require, on the part of the communication user:
searching for the contact either in a private address book or public directory to find a communication identifier: telephone number, e-mail address, social network profile address of the person sending the photograph,
then launching the corresponding service in the chosen communication mode before being able to reply.

Furthermore, digital photo albums today are often made up of personal photographs and photographs received, for example, in a message and recorded on a personal communication terminal or in a private storage space. When a communication user consulting a personal photo album wishes to communicate with the author of the photograph viewed, he sometimes has the possibility of finding the author in data associated with the photograph. The communication user may have to find the author of the photograph or the person having sent this photograph to him, which may prove complex or even impossible. Nevertheless, if the communication user finds this person, the setting up of the communication with this person will remain complex as it will again require the finding of the contact and the launching of the required communication service.

### SUMMARY

One of the objects of the present invention is to overcome shortcomings of the prior art.

A subject-matter of the invention is a multimedia content enrichment method comprising an association of at least one identifier of a first user with multimedia content during management of said content by a communication terminal of said first user, said association allowing a second user having access to said multimedia content to request setting up of a communication between a communication terminal of said second user and a communication terminal of said first user by using one of said at least one identifiers of said first user.

Thus, the second user receiving or consulting multimedia content enriched in this way will be able to be put into contact in a simple manner with the first user.

Advantageously, said enrichment method comprises a search for at least one identifier of said first user prior to said association.

Thus, all of the multimedia content originating from the first user will be enriched, facilitating the establishment of contact for all recipients of multimedia content of the first user.

Advantageously, said enrichment method comprises a selection of at least one identifier of said first user prior to said association.

Thus, the first user can limit the communication terminals and/or the communication modes of the first user with which the recipients of enriched multimedia content can request an establishment of contact.

Advantageously, said association is carried out by writing said at least one identifier of said first user into at least one metadatum of said multimedia content.

Thus, the identifier allowing the establishment of contact is directly transported by the multimedia content file with the useful multimedia content: i.e. a transmitted photo file comprises the useful data allowing the photo image to be formed and metadata in which the resolution of the image, the size of the image, etc. are generally recorded, and, in the context of the invention, an identifier of the first user. Thus, the communication terminal of the second user will receive, along with the useful data of the image, the identifier of the first user and will not have to search for this identifier associated with this photo, notably in a database of a communication network.

Advantageously, according to one embodiment of the invention, the different steps of the method according to the invention are carried out by a computer program or software, this software comprising software instructions intended to be executed by a data processor of an enrichment device and being designed to control the carrying out of the different steps of the method.

The invention therefore also relates to a program comprising program code instructions for carrying out the steps of the multimedia content enrichment method according to any one of the preceding claims when said program is executed by a processor.

Another subject-matter of the invention is a multimedia content enrichment device comprising means for associating at least one identifier of a first user with multimedia content during a management of said content by a communication terminal of said first user, said association allowing a second user having access to said multimedia content to request the setting up of a communication between a communication terminal of said second user and a communication terminal of said first user by using one of said at least one identifiers of said first user.

A subject-matter of the invention is also a multimedia content management method which, following a multimedia content management request by a communication terminal of a first user, comprises an association of at least one identifier of said first user with said multimedia content during said management of said multimedia content, said association allowing a second user having access to said multimedia content to request the setting up of a communication between a communication terminal of said second user and a communication terminal of said first user by using one of said at least one identifiers of said first user.

Thus, when a first user creates, sends, publishes, shares, etc., multimedia content, the latter is automatically enriched by an identifier of the first user then allowing a second user receiving or consulting this enriched multimedia content to be put into contact in a simple manner with the first user.

Advantageously, according to one embodiment of the invention, the different steps of the method according to the invention are carried out by a computer program or software, this software comprising software instructions intended to be executed by a data processor of a device forming part of a communication terminal and being designed to control the execution of the different steps of this method.

The invention therefore also relates to a program comprising program code instructions to carry out the steps of the multimedia content management method according to the preceding claim when said program is executed by a processor.

A further subject-matter of the invention is a multimedia content management device comprising means which, following a multimedia content management request by a communication terminal of a first user, associate at least one identifier of said first user with said multimedia content during said management of said multimedia content, said association allowing a second user having access to said multimedia content to request the setting up of a communication between a communication terminal of said second user and a communication terminal of said first user by using one of said at least one identifier(s) of said first user.

A subject-matter of the invention is a communication terminal comprising a multimedia content management device which, following a multimedia content management request by a communication terminal of a first user, associates at least one identifier of said first user with said multimedia content during said management of said multimedia content, said association allowing a second user having access to said multimedia content to request the setting up of a communication between a communication terminal of said second user and a communication terminal of said first user by using one of said at least one identifier(s) of said first user.

Thus, the enrichment operation is directly implemented in the communication terminal of the first user.

Another subject-matter of the invention is a service provision device comprising a multimedia content management device which, following a multimedia content management request by a communication terminal of a first user, is suitable for associating at least one identifier of said first user with said multimedia content during said management of said multimedia content, said association allowing a second user having access to said multimedia content to request the setting up of a communication between a communication terminal of said second user and a communication terminal of said first user by using at least one of said at least one identifier(s) of said first user.

Thus, a service provider, notably a provider of a multimedia content management service, such as a photo and photo album creation service, will be able to offer this enrichment of the multimedia content to its users.

A subject-matter of the invention is moreover a method for setting up a communication from a terminal of a second user with a terminal of a first user which, following a communication request from a second user while accessing multimedia content enriched with at least one identifier of a first user, comprises a transmission of a message from said communication terminal of said second user to a communication terminal of said first user by using one of said at least one identifier(s) of said first user.

Thus, a second user will not have to search in his contacts or in a public directory for an identifier of the first user in order to be able to communicate with him if he wishes to change communication mode compared with the communication mode used for the transmission of the multimedia content.

Advantageously, according to one embodiment of the invention, the different steps of the method according to the invention are carried out by a computer program or software, this software comprising software instructions intended to be executed by a data processor of a device forming part of a communication terminal and being designed to control the carrying out of the different steps of this method.

The invention therefore also relates to a program comprising program code instructions for carrying out the steps of the method for setting up a communication according to the preceding claim, when said program is executed by a processor.

These programs can use any programming language and can be in the form of source code, object code or intermediate code between source code and object code, such as in a partially compiled form or in any other desirable form.

A subject-matter of the invention is also a device for setting up a communication from a terminal of a second user with a terminal of a first user comprising a transmitter of a message, said message being transmitted, following a communication request from a second user while accessing multimedia content enriched with at least one identifier of a first user, from said communication terminal of said second user to a communication terminal of said first user using one of said at least one identifier(s) of said first user.

A further subject-matter of the invention is a communication terminal comprising a device for setting up a communication from a terminal of a second user with a terminal of a first user suitable for transmitting a message, said message being transmitted, following a communication request from a second user while accessing multimedia content enriched with at least one identifier of a first user, from said communication terminal of said second user to a communication terminal of said first user using one of said at least one identifier(s) of said first user.

### BRIEF DESCRIPTION OF THE DRAWINGS

The characteristics and advantages of the invention will become clearer from reading the description, given by way of example, and the related figures, in which:

FIG. 1 shows a simplified diagram of the methods carried out by the invention in a first alternative embodiment of the invention in which a communication terminal of a user carries out an enrichment method according to the invention,

FIG. 2 shows a simplified diagram of the methods carried out by the invention in a second alternative embodiment of the invention in which a service provision device carries out an enrichment method according to the invention,

FIG. 3 shows a simplified diagram of a first communication architecture implementing a content management device and an enrichment device according to the invention in a communication terminal,

FIG. 4 shows a simplified diagram of a first communication architecture implementing a content management device and an enrichment device according to the invention in a service provision device,

FIGS. 5a to 5g show diagrams of a scenario illustrating a use of the invention.

### DETAILED DESCRIPTION

In a general manner, the invention proposes to associate at least one identifier of a first user with multimedia content during its management by the first user. Thus, when a second user receives this multimedia content from the first user, the second user will easily be able to request to be put into contact with the sender of this multimedia content, in this case the first user: the terminal of the second user using the identifier of the first user associated with the multimedia content received to set up a communication between the second user and the first user.

Multimedia content is understood to mean any type of content transmissible by message, publication or sharing, etc.: and also simple text files with or without formatting, photographs, audio and/or voice files, videos, applications such as games, any processing tools or means, etc.

Multimedia content management is understood to mean any processing of multimedia content such as a creation and/or modification of multimedia content, a transmission of multimedia content by message, publication, sharing, etc.

Identifiers of a user are understood to mean any communication identifier such as a fixed, mobile, IP telephone number, etc., but also an e-mail address allowing exchanges by e-mail or IM, etc., any social identifier allowing a transmission to a user determined by his social identifier of data, notably multimedia content, for example by sharing or publication via a social network or any other service provider.

Associating an identifier with multimedia content is understood to mean that any communication terminal of a user having multimedia content (in his communication terminal or on a service provision device), once the association has been effected, will easily be able to have access to the identifier associated with the multimedia content. Notably, the association is recorded in a content database accessible by the user sending the multimedia content and the user receiving the multimedia content. An alternative is, in particular, that the association causes the writing of the identifier in the metadata of the multimedia content.

Communication is understood to mean any type of communication: synchronous and asynchronous communication, text, voice, video communication, etc., i.e. notably SMS, MMS, mobile telephony, fixed telephony, VoIP, video, IP video, e-mail, IM, but also the sending of physical mail (text and/or photo and/or video) to a postal address via a service provider such as the Internet portal of the postal service converting electronic messages into physical mail (paper, DVD, etc.), etc.

Setting up of a communication is therefore understood to mean not only the simple sending of a message to a recipient but also the setting up of a communication session for a synchronous communication.

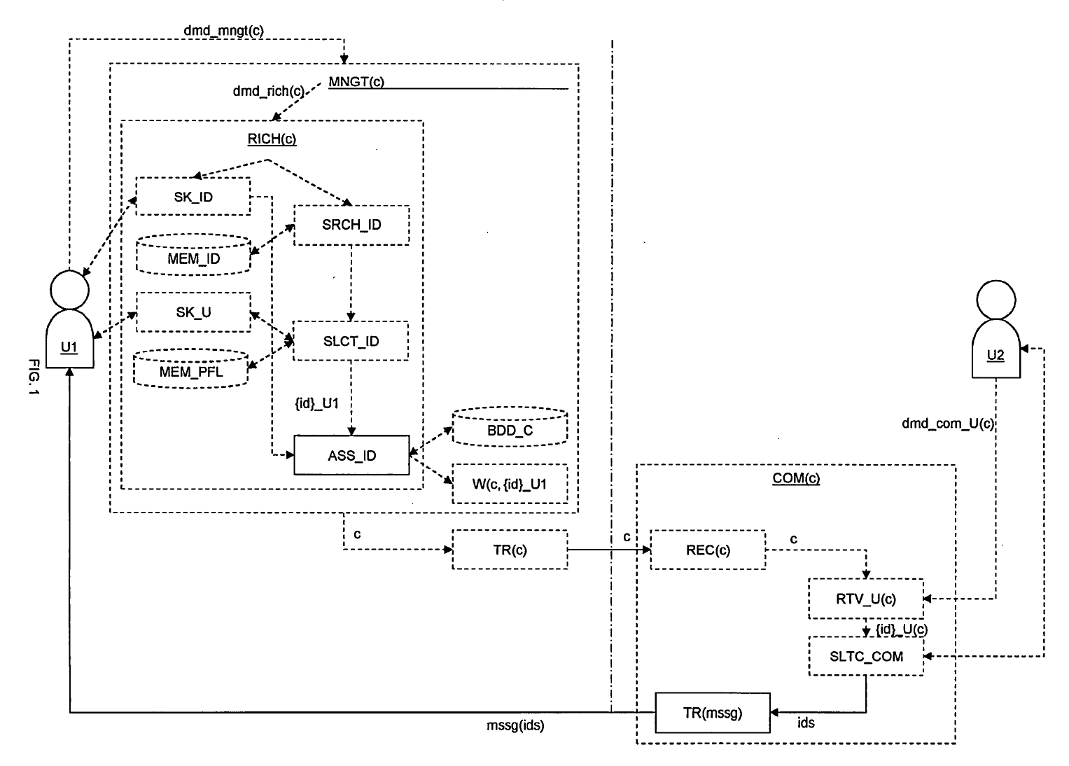

FIG. 1 shows a simplified diagram of the methods carried out by the invention in a first alternative embodiment of the invention in which a communication terminal of a user carries out an enrichment method according to the invention.

A method RICH(c) for enriching multimedia content comprises an association ASS_ID of at least one identifier {id}_U1 of a first user U1 with multimedia content c during a management MNGT(c) of said content c by a communication terminal of said first user U1. The association ASS_ID allows a second user U2 having access REC(c) to said multimedia content c to request a setting up of a communication TR(mssg) between a communication terminal of said second user U2 and a communication terminal of said first user U1 by using one of said at least one identifier(s) of said first user ids.

In particular, the enrichment method RICH(c) comprises a search SRCH_ID for at least one identifier of said first user U1 prior to said association ASS_ID. The search SRCH_ID is carried out, notably, in a memory MEM_ID of the communication terminal of the first user U1 or in a database of the identifiers of the first user (not shown) of a communication terminal of the first user or of a service provision device.

In an alternative or complementary manner, the enrichment method RICH(c) comprises an identifier request SK_ID to the first user U1, notably via an interface of the communication terminal.

In particular, the enrichment method RICH(c) comprises a selection of at least one identifier of said first user SLCT_ID prior to said association ASS_ID. In fact, a first user may have a plurality of identifiers, such as a personal mobile telephone number, a business mobile telephone number, a business e-mail address, etc. In this case, the enrichment method will comprise a selection SLCT_ID of some of his identifiers in order to associate them with the multimedia content: for example, the personal mobile telephone number will be associated with a personal photo, and the business e-mail address will be associated with a business presentation. To carry out this selection SLCT_ID, the enrichment method RICH(c) will be able to use, in an alternative or complementary manner, a selection request to the user SK_U and a profile of the user stored in a memory MEM_PFL of the communication terminal of the first user. For example, the user profile will indicate to a category of multimedia content and/or recipients of the multimedia content, the identifiers to be selected according to their category. The categories are notably the distinction between personal and business or the knowledge groups of a social network, etc.

In particular, the association ASS_ID is effected by writing W(c, {id}_U1) said at least one identifier of said first user into at least one metadatum of said multimedia content c.

In an alternative manner, the association ASS_ID is effected by recording the multimedia content c or an identifier of the multimedia content with at least one identifier of said first user {id}_U1 in a multimedia content database BDD_C accessible by any recipient of said multimedia content c.

This multimedia content enrichment method can be carried out, notably in a communication terminal of a first user, in the form of a program comprising program code instructions for carrying out the steps of the enrichment method when said program is executed by a processor, notably a processor of the communication terminal in the example shown in FIG. 1.

Following a multimedia content management request dmd_mngt(c) by a communication terminal of a first user U1, a multimedia content management method MNGT(c) comprises the association ASS_ID of at least one identifier of said first user with said multimedia content during said management MNGT(c) of said multimedia content.

In particular, the management method MNGT(c) comprises the enrichment method RICH(c) instigated by an enrichment request dmd_rich(c) of the management method MNGT(c).

This management method can be carried out, notably in a communication terminal of the first user, in the form of a program comprising program code instructions to carry out the steps of the multimedia content management method when said program is executed by a processor, notably a processor of the communication terminal of the first user.

The multimedia content management method MNGT(c) is notably a method for transmitting multimedia content c to a communication terminal of a second user U2. In an alternative manner, multimedia content c already associated with an identifier of the first user by the enrichment method RICH(c) can be transmitted TR(c) by the communication terminal of the first user U1.

Following a communication request dmd_com_U(c) from a second user U2 while accessing multimedia content c enriched with at least one identifier of a first user U1, a method for setting up a communication COM(c) from a terminal of a second user U2 with a terminal of a first user U1 comprises a transmission TR(mssg) of a message mssg(ids) from said communication terminal of said second user U2 to a communication terminal of said first user U1 using one of said at least one identifier(s) of said first user ids.

In particular, the method for setting up a communication comprises a reception REC(c) by the communication terminal of the second user U2 of the enriched multimedia content c.

The method for setting up a communication comprises, notably, reading of the metadata RTV-U(c) to find the identifiers associated with the received multimedia content {id}_U(c).

When multimedia content is associated with a plurality of types of identifier: telephone number, e-mail address, etc., the method for setting up a communication comprises, in particular, a selection SLTC_COM of an identifier which will be used to set up the communication. The selection SLTC_COM is notably a function:
of the communication mode required by the second user in his request dmd_com_U(c), or
of a communication mode selected by the second user from the possible communication modes, taking account of the identifiers associated with the content, notably via a selection interface (not shown), or
of an identifier selected by the second user from the identifiers associated with the content, notably via a selection interface (not shown),
etc.

This method for setting up a communication is notably carried out in the form of a program comprising program code instructions for carrying out the steps of the method for setting up a communication when said program is executed by a processor, such as a processor of the communication terminal of the second user.

In a mirror image (not shown), the second user can use an enrichment method on multimedia content before transmitting it to a different user, notably to the first user. The multimedia content will then be enriched with at least one identifier of the second user allowing the first user using the method for setting up a communication according to the invention easily to set up a communication with the second user on the basis of the received multimedia content.

FIG. 2 shows a simplified diagram of the methods carried out by the invention in a second alternative embodiment of the invention in which a service provision device carries out an enrichment method according to the invention.

In the case shown by FIG. 2, an enrichment method is carried out by a service provision device DFS (in particular a content enrichment service) to which the first user may have subscribed.

The identifiers of the first user are then notably stored in a database of identifiers BDD_ID of the service provision device DFS bringing together the identifiers of the users having subscribed at least to the enrichment service, or to any one of the services provided by the services device DFS. Moreover, the profile of the first user is in particular stored in a profile database BDD_PFL of the service provision device DFS bringing together the profiles of the users having subscribed to the enrichment service.

The first user U1 requests management of multimedia content dmd_mngt(c). During the management or at the beginning of the processing, or during processing, or once the processing is completed (notably the creation of multimedia content) by a method MNGT(c) for managing the multimedia content c, the communication terminal of the first user U1 carrying out the management method MNGT(c) requests the enrichment of the content dmd_rich(c) from the service provision device DFS which instigates the enrichment method RICH(c) on this multimedia content.

The method RICH(c) for enriching multimedia content comprises an association ASS_ID of at least one identifier {id}_U1 of a first user U1 with multimedia content c during management MNGT(c) of said content c by a communication terminal of said first user U1. The association ASS_ID allows a second user U2 having access REC(c) to said multimedia content c to request setting up of a communication TR(mssg) between a communication terminal of said second user U2 and a communication terminal of said first user U1 by using one of said at least one identifier(s) of said first user ids.

In particular, the enrichment method RICH(c) comprises a search SRCH_ID for at least one identifier of said first user U1 prior to said association ASS_ID. The search SRCH_ID is carried out notably in a database of identifiers BDD_ID of the service provision device DFS.

In an alternative or complementary manner, the enrichment method RICH(c) comprises an identifier request SK_ID to the first user U1, notably via an interface of the communication terminal (not shown).

In particular, the enrichment method RICH(c) comprises a selection of at least one identifier of said first user SLCT_ID prior to said association ASS_ID. To carry out this selection SLCT_ID, the enrichment method RICH(c) will be able, in an alternative or complementary manner, to use a selection request to the user SK_U and a profile of the user stored in a profile database BDD_PFL of the service provision device DFS.

In particular, the association ASS_ID is carried out by writing W(c, {id}_U1) of said at least one identifier of said first user in at least one metadatum of said multimedia content c. Either, as shown in FIG. 2, the enrichment method provides the identifier(s) and instigates the writing of these identifiers into the metadata of the multimedia content by the content management method, or the enrichment method comprises the writing (not shown) of these identifiers into the metadata of the multimedia content, the enrichment method having received the multimedia content or the address of the multimedia content in a content database BDD_C with the enrichment request dmd_rich(c).

In an alternative manner, the association ASS_ID is carried out by recording the multimedia content c or an identifier of the multimedia content with at least one identifier of said first user {id}_U1 in a multimedia content database BDD_C accessible by any recipient of said multimedia content c. Either, as shown in FIG. 2, the enrichment method provides the identifier(s) and instigates the recording of the identifiers in the content database BDD_C, or the enrichment method comprises the recording (not shown) of these identifiers in the content database BDD_C, the enrichment method having received the multimedia content or the address of the multimedia content in a content database BDD_C with the enrichment request dmd_rich(c).

This multimedia content enrichment method can be carried out notably in a service provision device in the form of a program comprising program code instructions for carrying out the steps of the enrichment method when said program is executed by a processor, notably a processor of the service provision device in the example shown by FIG. 2.

Following a multimedia content management request dmd_mngt(c) by a communication terminal of a first user U1, a multimedia content management method MNGT(c) comprises the instigation of an association ASS_ID of the at least one identifier of said first user with said multimedia content during said management MNGT(c) of said multimedia content.

In particular, the management method MNGT(c) comprises an enrichment request dmd_rich(c).

This management method can be carried out, notably in a communication terminal of the first user, in the form of a program comprising program code instructions to carry out the steps of the multimedia content management method when said program is executed by a processor, notably a processor of the communication terminal of the first user.

The multimedia content c associated with an identifier of the first user by the enrichment method RICH(c) can be transmitted TR(c) by the communication terminal of the first user U1.

A communication terminal of a second user U2 receiving the enriched content c carries out a method for setting up a communication COM(c) from the terminal of a second user U2 with a terminal of a first user U1.

In particular, the method for setting up a communication comprises a reception REC(c) by the communication terminal of the second user U2 of the enriched multimedia content c.

The method for setting up a communication comprises, notably, reading of the metadata RTV-U(c) to find the identifiers associated with the received multimedia content {id}_U(c).

When multimedia content is associated with a plurality of types of identifier: telephone number, e-mail address, etc., the method for setting up a communication comprises, in particular, a selection SLTC_COM of an identifier which will be used to set up the communication.

Following a communication request dmd_com_U(c) from the second user U2 while accessing the multimedia content c enriched with at least one identifier of the first user U1, this method for setting up a communication COM(c) comprises a transmission TR(mssg) of a message mssg(ids) from said communication terminal of said second user U2 to a communication terminal of said first user U1 using one of said at least one identifier(s) of said first user ids.

This method for setting up a communication is notably carried out in the form of a program comprising program code instructions for carrying out the steps of the communication set-up method when said program is executed by a processor, such as a processor of the communication terminal of the second user.

In a mirror image (not shown), the second user can use an enrichment method on multimedia content before transmitting it to a different user, notably to the first user. The multimedia content will then be enriched with at least one identifier of the second user allowing the first user using the communication set-up method according to the invention easily to set up a communication with the second user on the basis of the received multimedia content.

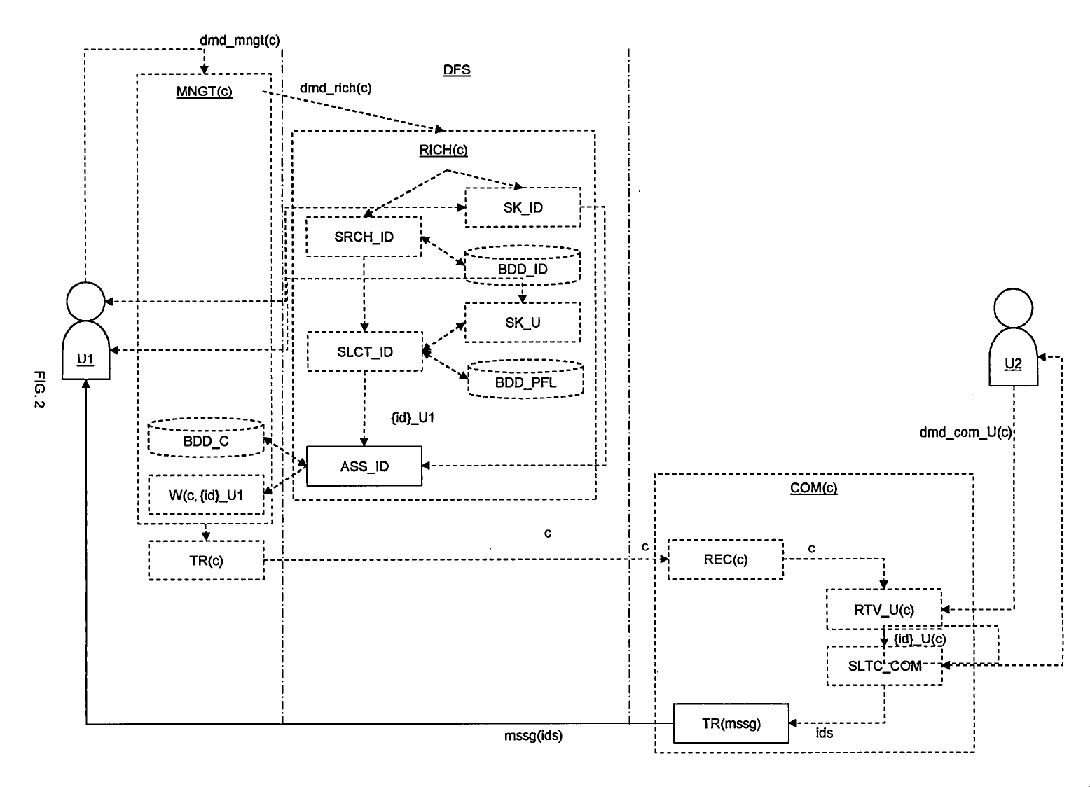

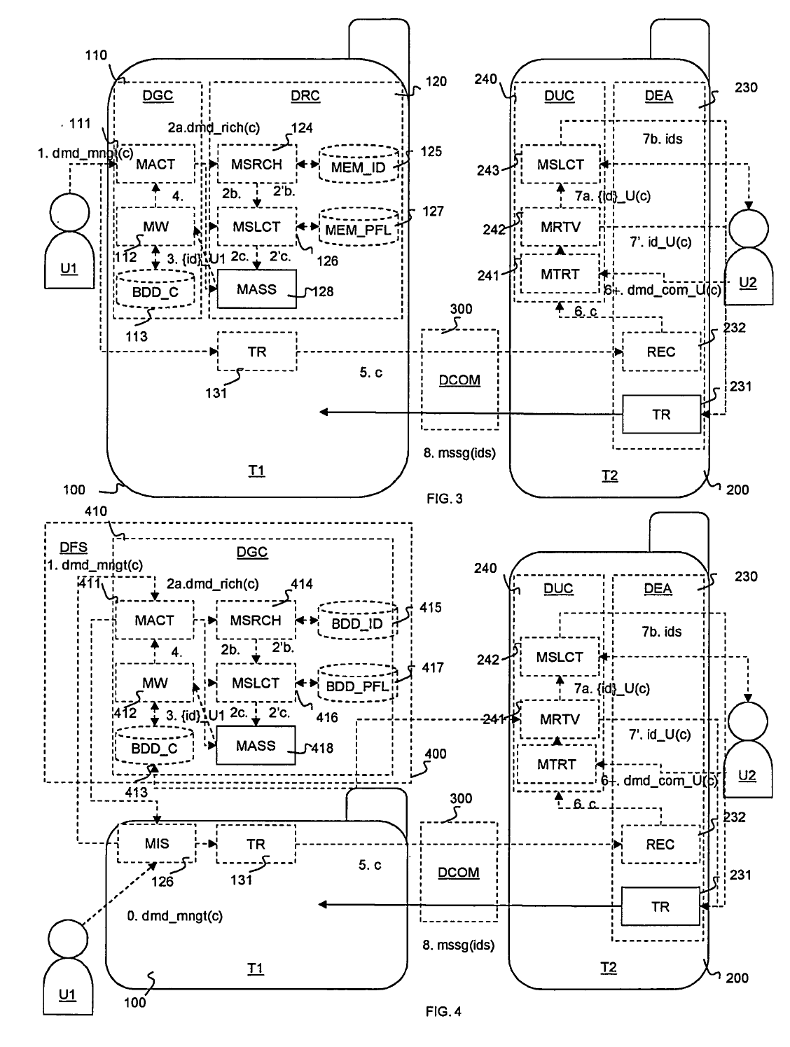

FIG. 3 shows a simplified diagram of a first communication architecture implementing a content management device and an enrichment device according to the invention in a communication terminal.

The communication architecture comprises notably a communication terminal T1 100 of a first user U1, a communication terminal T2 200 of a second user U2, and possibly a communication device DCOM 300.

The communication terminal T1 100 of a first user comprises either an enrichment device 120 as shown in FIG. 3, or directly association means MASS 125 of at least one identifier of a first user U1 with multimedia content c during management of said content by a communication terminal T1 100 of said first user. The association allows a second user U2 having access to said multimedia content c to request the setting up of a communication between a communication terminal T2 200 of said second user U2 and a communication terminal T1 100 of said first user U1 by using one of said at least one identifier(s) of said first user U1.

The multimedia content enrichment device DRC 120 comprises means MASS 125 for associating at least one identifier of a first user U1 with multimedia content c.

In particular, the enrichment device 120 comprises one or more of the following means:
search means MSRCH 121
selection means MSLCT 123
an identifier memory MEM_ID 122
a profile memory MEM_PFL 124
   The search means 121 are connected to the identifier memory 122 in which they search for the identifiers of the first user U1.

In an alternative or complementary manner, the enrichment device 120 comprises means for requesting an identifier from the first user U1, notably via an interface of the communication terminal (not shown).

The means 123 for selecting at least one identifier of said first user SLCT_ID are placed prior to the association means 125. The selection means 123 are notably connected to the profile memory 124 to carry out this selection according to a profile of the first user U1. In an alternative or complemented manner, the selection means 123 request the user SK_U to select one or more identifiers, notably via an interface of the communication terminal (not shown).

In particular, the association means 125 instigate writing of said at least one identifier of said first user U1 into at least one metadatum of said multimedia content c.

In an alternative manner, the association means 125 record (not shown) the multimedia content c or an identifier of the multimedia content with at least one identifier of said first user {id}_U1 in a multimedia content database BDD_C accessible by any recipient of said multimedia content c and instigate, as shown in FIG. 3, the recording of the identifiers in the content database BDD_C.

In particular, the communication terminal 100 comprises a multimedia content management device DGC 110. The content management device 110 requests the enrichment of the content dmd_rich (c) either directly from the association means 125 which will possibly control the search means 121 and/or the selection means 123 (not shown), or, in a more general manner, from the enrichment device 120 as shown in FIG. 3, or the search means 121 (not shown).

The content management device 110 comprises (not shown), notably, the enrichment device 120 or the association means 125.

In particular, the content management device 110 comprises one or more of the following means:
processing means MACT 111
writing and/or recording means 112
a content database BDD_C 113
   The processing means 111 receive a content management request 1. dmd_mngt(c) from the first user U1. The processing means are connected either directly to the association means 125 (not shown), or to the enrichment device 120 to transmit a managed content enrichment request dmd_rich(c) before or after the processing, or at a predetermined time of the processing.

In particular, during a management consisting in a transmission of the content via a predefined communication mode such as e-mail, MMS, etc., the processing means 111 are connected to transmission means TR 131. The processing means 111 attach the content once enriched to the message and transmit the message with the attached enriched content to the transmission means 131.

In particular, the processing means 111 are connected to the content database 113 (not shown) notably to load the selected content for the purpose of carrying out its processing and/or sending it to the enrichment device 120.

In particular, the writing and/or recording means 112 are connected to the association means 125 which control them. The writing and/or recording means 112 are notably connected to the content database 113 in order to write either into the metadata of content of the database, or to record the identifiers, linked with content of the database, in the database, or to record enriched content.

In particular, the writing and/or recording means 112 are connected to the processing means 111 either to transmit the enriched content or to indicate that the enrichment is completed, and/or to instigate the following step of the processing.

The communication terminal 200 of the second user U2 comprises a device for setting up a communication DEA 230 from a terminal 200 of a second user with a terminal 100 of a first user suitable for transmitting a message. The message is transmitted 8. mss(ids), following a communication request 6+. Dmd_com_U(c) from the second user U2 while accessing multimedia content enriched with at least one identifier of a first user, from said communication terminal 200 of said second user to a communication terminal 100 of said first user using one of said at least one identifiers of said first user U1.

The device for setting up a communication 230 from the terminal 200 of the second user with a terminal 100 of the first user U1 comprises a transmitter TR 231 of messages following a communication request 6+. Dmd_com_U(c) from the second user U2 while accessing multimedia content enriched with at least one identifier of the first user.

In particular, the device for setting up a communication 230 comprises reception means REC 232. The reception means 232 notably receive messages from a terminal 100 of a first user U1 comprising enriched multimedia content 5. c, for example via a communication device DCOM, or published or shared enriched multimedia content. The reception means 232 are connected at least indirectly to the transmission means 231 in such a way that enriched multimedia content received by the reception means 232 from a terminal 100 of a first user U1 allows the transmission means 231, following a request from the second user U2 6+. Dmd_com_U(c), to transmit a message to the terminal 100 of the first user whose identifier enriches the received multimedia content c.

In particular, the communication terminal 200 comprises a device for using enriched multimedia content DUC 240. In one embodiment not shown, the device for setting up a communication 230 comprises the content usage device 240.

Usage of enriched multimedia content is understood notably to mean the display of a link to at least a part of all of the multimedia content available on the communication terminal 200, the display of a message comprising multimedia content enriched with a link allowing the opening of said multimedia content, the reproduction, modification, publication, sharing of the multimedia content, the insertion of the multimedia content into a message, etc., i.e. any usage requiring direct access or at least access to a link to said multimedia content.

In particular, the content usage device 240 comprises one or more of the following means:
processing means MTRT 241
recovery means MRTV 242
selection means MSLCT 243
   The processing means 241 are suitable for receiving enriched multimedia content 6. c, notably reception means 232 to which they are, in particular, connected. The processing means 241 comprise, for example, an interface allowing the second user U2 to request 6+. Dmd_com_U(c) the setting up of communication with the user who has transmitted the multimedia content to him during a consultation, in this case with the first user U1.

The processing means 241 are notably connected to recovery means 242 suitable for reading metadata of the enriched multimedia content c during usage to find the identifiers associated with the received multimedia content 7a. {id}_U(c).

The recovery means 242 are, in particular, connected to selection means 243. Thus, when multimedia content c is associated with a plurality of types of identifier, the recovery means 242 supply the list of identifiers read in the metadata of the enriched multimedia content c to the selection means 243.

The selection means 243 comprise, for example, an interface allowing the second user U2 to select one of the identifiers or a communication mode, etc.: the selection means 243 select an identifier according to the selection made by the second user U2.

The selection means 243 and/or the recovery means are notably connected to the transmission means 231 allowing the transmission of an identifier 7′. id_U(c), 7b. ids of the first user U1.

In a mirror image (not shown), the terminal 200 of the second user U2 may comprise a device for enriching multimedia content before transmitting it to a different user, notably to the terminal 100 of the first user U1. The multimedia content will then be enriched with at least one identifier of the second user allowing the terminal 100 of the first user comprising a device for setting up a communication according to the invention easily to set up a communication with the second user on the basis of the received multimedia content.

FIG. 4 shows a simplified diagram of a first communication architecture implementing a content management device and an enrichment device according to the invention in a service provision device.

In this embodiment of the invention, the communication architecture comprises notably a communication terminal T1 100 of a first user U1, a communication terminal T2 200 of a second user U2, a service provision device DFS 400 and possibly a communication device DCOM 300.

The communication terminal T1 100 of a first user comprises means MIS 126 for interfacing with the service provision device 400 notably to transmit the content management request 0. dmd_mngt(c) received from the first user U1.

The service provision device 400 comprises either an enrichment device 420 as shown in FIG. 4, or directly means MASS 425 for associating at least one identifier of a first user U1 with multimedia content c during management of said content by the first user U1. The association allows a second user U2 having access to said multimedia content c to request the setting up of a communication between a communication terminal T2 200 of said second user U2 and a communication terminal T1 100 of said first user U1 by using one of said at least one identifier(s) of said first user U1.

The multimedia content enrichment device DRC 420 comprises means MASS 425 for associating at least one identifier of a first user U1 with multimedia content c.

In particular, the enrichment device 420 comprises one or more of the following means:
search means MSRCH 421
selection means MSLCT 423
an identifier database BDD_ID 422
a profile database BDD_PFL 424
   The search means 421 are connected to the identifier database 422 in which they search for the identifiers of the first user U1.

The means 423 for selecting at least one identifier of said first user SLCT_ID are placed prior to the association means 425. The selection means 423 are notably connected to the profile database 424 to carry out this selection according to a profile of the first user U1.

In particular, the association means 425 instigate writing of said at least one identifier of said first user U1 into at least one metadatum of said multimedia content c.

In an alternative manner, the association means 425 record (not shown) the multimedia content c or an identifier of the multimedia content with at least one identifier of said first user {id}_U1 in a multimedia content database BDD_C 413 accessible by any recipient of said multimedia content c and instigate, as shown in FIG. 4, the recording of the identifiers in the content database BDD_C.

In particular, the service provision device 400 comprises a multimedia content management device DGC 410. The content management device 410 requests the enrichment of the content dmd_rich (c) from the enrichment device 420 in the example in FIG. 4.

The content management device 410 comprises (not shown), notably, the enrichment device 420 or the association means 425.

In particular, the content management device 410 comprises one or more of the following means:
processing means MACT 411
writing and/or recording means 412
a content database BDD_C 413

The processing means 411 receive a content management request 1. dmd_mngt(c) from the terminal 100 of the first user U1. The processing means 411 are connected to the enrichment device 420 to transmit a managed content enrichment request dmd_rich(c) before or after the processing, or at a predetermined time of the processing.

In particular, during management consisting in a transmission of the content via a predefined communication mode such as e-mail, MMS, etc., the processing means 411 are connected to transmission means TR 131 of the terminal 100 of the first user which will transmit the enriched content 5. c, notably via a communication device 300.

In particular, the writing and/or recording means 412 are connected to the association means 425 which control them. The writing and/or recording means 412 are notably connected to the content database 413 in order either to write into the metadata of content of the database, or to record the identifiers, linked with content of the database, in the database, or to record enriched content.

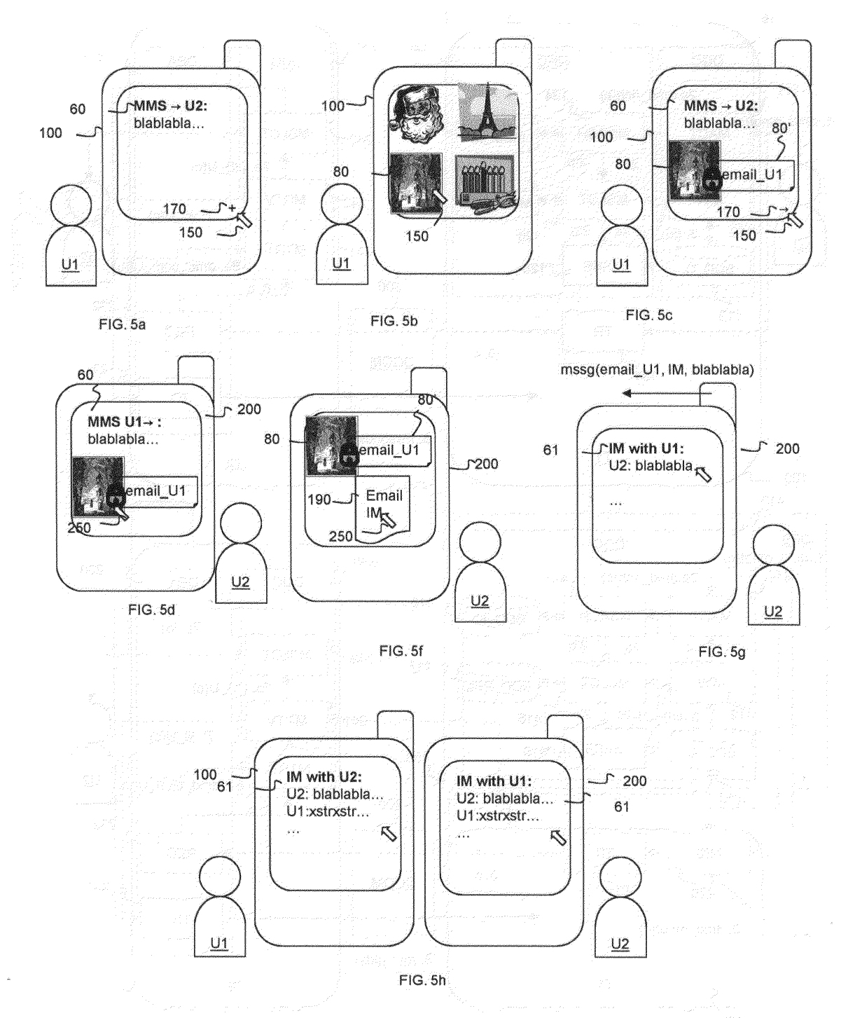

FIGS. 5a to 5g show diagrams of a scenario illustrating a use of the invention.

A first user U1 writes a multimedia message such as an MMS 60 to a second user U2 on his communication terminal, for example a mobile telephone or Smartphone 100. The first user U1 selects with his cursor 150 the option of inserting objects 170 into his message 60 as shown in FIG. 5a.

The interface of his mobile telephone 100 proposes, as objects to insert, a series of images to insert, from which the first user U1 selects with his cursor 150 the image 80 as shown in FIG. 5b.

The interface of the mobile telephone 100 of the first user U1 then reproduces the multimedia message 60 in which the image 80 previously enriched by the enrichment method according to the invention via an identifier 80′ of the first user: in this case, the e-mail address of the first user: email_U1 recorded in its metadata (as shown by the padlock associating the image 80 and the identifier 80′). The first user U1 selects the sending 170 of the message 60 made up in this way to the second user U2 as shown in FIG. 5c.

The second user U2 receives the multimedia message 60 originating from the terminal 100 of the first user on a communication terminal 200, notably a Smartphone. The second user U2 wishes to respond to the received image, but does not wish to reply by MMS, but by electronic messaging instead (notably due to the discussion archiving facility). The second user U2 selects with his cursor 250 the access to the options linked to the enriched multimedia content received in the message 60 as shown in FIG. 5d.

The communication terminal 200 proposes, according to the identifier 80′ associated with the multimedia content 80, a communication mode selection list 190: In this case, the identifier 80′ being an e-mail address, the selection list comprises the modes of communication via electronic messaging email or via instant messaging IM. The second user selects 250 instant messaging IM as shown in FIG. 5e.

The Smartphone 200 requests the opening of an instant messaging session mssg(email_U1, IM, blablabla) with a communication terminal of the first user U1 associated with the identifier 80′, in this case the mobile telephone 100. And, the second user begins a discussion with the first user relating to the received image 80, as shown in FIG. 5f.

Thus, the first user, by means of his terminal 100, and the second user, by means of his terminal 200, perform the exchange (FIG. 5g) via instant messaging in a session set up on the basis of enriched multimedia content.

It can be envisaged in a different scenario that, between the reception of the MMS (FIG. 5d) and the use of the enriched content to set up a communication (FIG. 5e), the enriched content is stored independently from the message in which it was transmitted, notably in an album. Thus, in consulting this album sometime later, the second user U2 wishes to ask a question concerning the image to the person who transmitted it to him and/or to the author of the multimedia content (i.e. a first user having created the content), it will be easy for him, without even searching for the message via which the content was transmitted to him or the page of publication or sharing of the content, to make contact with this person as shown in FIGS. 5e to 5g.

In a more general manner, content can be enriched with one or more identifiers of one or more first users, thus allowing the possible saving of the transmission chain of the multimedia content or at least its author and/or the first user having directly transmitted the multimedia content to the second user. Moreover, this allows the second user simply to set up a communication or conference with one or more of the first users whose at least one identifier enriches said multimedia content.

The invention also relates to one or more information media. An information medium may be any entity or device capable of storing at least one of the programs according to the invention. For example, the medium may comprise a storage means, such as a ROM, for example a CD-ROM or microelectronic circuit ROM, or a magnetic recording means, for example a diskette or hard disk.

Moreover, the information medium may be a transmissible medium such as an electrical or optical signal that can be routed via an electrical or optical cable, by radio or by other means. The program according to the invention may, in particular, be downloaded from a network, notably an Internet network.

Alternatively, the information medium may be an integrated circuit into which the program is incorporated, the circuit being suitable for carrying out or for being used in the carrying out of the method in question.

In a different embodiment, the invention is implemented by means of software and/or hardware components. In this context, the term module may correspond equally to a software component or to a hardware component. A software component corresponds to one or more computer programs, one or more sub-programs of a program, or, in a more general manner, to any element of a program or of software suitable for performing a function or a set of functions according to the description below. A hardware component corresponds to any element of a hardware assembly suitable for performing a function or a set of functions.

1. A multimedia content enrichment method comprising an association of at least one identifier of a first user with multimedia content during management of said content by a communication terminal of said first user, said association allowing a second user having access to said multimedia content to request setting up of a communication between a communication terminal of said second user and a communication terminal of said first user by using one of said at least one identifiers of said first user.

2. The enrichment method according to claim 1, wherein said enrichment method comprises a search for at least one identifier of said first user prior to said association.

3. The enrichment method according to claim 1, wherein said enrichment method comprises a selection of at least one identifier of said first user prior to said association.

4. The enrichment method according to claim 1, wherein said association is effected by writing said at least one identifier of said first user into at least one metadatum of said multimedia content.

5. A non-transitory computer program product comprising program code instructions for carrying out the steps of the multimedia content enrichment method according to claim 1 when said program is executed by a processor.

6. A multimedia content enrichment device comprising means for associating at least one identifier of a first user with multimedia content during management of said content by a communication terminal of said first user, said association allowing a second user having access to said multimedia content to request the setting up of a communication between a communication terminal of said second user and a communication terminal of said first user by using one of said at least one identifier(s) of said first user.

7. A multimedia content management method which, following a multimedia content management request by a communication terminal of a first user, comprises an association of at least one identifier of said first user with said multimedia content during said management of said multimedia content, said association allowing a second user having access to said multimedia content to request the setting up of a communication between a communication terminal of said second user and a communication terminal of said first user by using one of said at least one identifier(s) of said first user.

8. A non-transitory computer program product comprising program code instructions for carrying out the steps of the multimedia content management method according to claim 7 when said program is executed by a processor.

9. A multimedia content management device which, following a multimedia content management request by a communication terminal of a first user, comprises means for associating at least one identifier of said first user with said multimedia content during said management of said multimedia content, said association allowing a second user having access to said multimedia content to request the setting up of a communication between a communication terminal of said second user and a communication terminal of said first user by using one of said at least one identifier(s) of said first user.

10. A communication terminal which, following a multimedia content management request by a communication terminal of a first user, comprises means for associating at least one identifier of said first user with said multimedia content during said management of said multimedia content, said association allowing a second user having access to said multimedia content to request the setting up of a communication between a communication terminal of said second user and a communication terminal of said first user by using one of said at least one identifier(s) of said first user.

11. A service provision device which, following a multimedia content management request by a communication terminal of a first user, comprises means for associating at least one identifier of said first user with said multimedia content during said management of said multimedia content, said association allowing a second user having access to said multimedia content to request the setting up of a communication between a communication terminal of said second user and a communication terminal of said first user by using one of said at least one identifier(s) of said first user.

12. A method for setting up a communication from a terminal of a second user with a terminal of a first user which, following a communication request from a second user while accessing multimedia content enriched with at least one identifier of a first user, comprises a transmission of a message from said communication terminal of said second user to a communication terminal of said first user using one of said at least one identifier(s) of said first user.

13. A non-transitory computer program product comprising program code instructions for carrying out the steps of the method for setting up a communication according to claim 12 when said program is executed by a processor.

14. A device for setting up a communication from a terminal of a second user with a terminal of a first user comprising a transmitter of a message, said message being transmitted, following a communication request from a second user while accessing multimedia content enriched with at least one identifier of a first user, from said communication terminal of said second user to a communication terminal of said first user using one of said at least one identifier(s) of said first user.

15. A communication terminal comprising a device for setting up a communication from a terminal of a second user with a terminal of a first user suitable for transmitting a message, said message being transmitted, following a communication request from a second user while accessing multimedia content enriched with at least one identifier of a first user, from said communication terminal of said second user to a communication terminal of said first user using one of said at least one identifier(s) of said first user.
